(19) United States
(12) Patent Application Publication
(10) Pub. No.: US 2026/0128860 A1
(43) Pub. Date: May 7, 2026

(54) ANONYMOUS AND UNLINKABLE AUTHENTICATION WITH MEMBERSHIP TEST VIA PRIVATE SET INTERSECTION CARDINALITY

(71) Applicant: NEC Laboratories Europe GmbH, Heidelberg (DE)

(72) Inventors: Christiane KUHN, Heidelberg (DE); Giorgia Azzurra MARSON, Heidelberg (DE); Sebastien ANDREINA, Heidelberg (DE)

(21) Appl. No.: 19/105,047

(22) PCT Filed: Jun. 27, 2023
(86) PCT No.: PCT/IB2023/056617

§ 371 Date: Feb. 20, 2025

Related U.S. Application Data
(60) Provisional application No. 63/455,276, filed on Mar. 29, 2023.

(51) Int. Cl. H04L 9/06; H04L 9/32

(52) U.S. Cl. CPC H04L 9/0656; H04L 9/3218

(57) ABSTRACT

A computer-implemented method anonymously verifies credentials while performing a membership test in a privacy-preserving manner. The method includes: executing a first committed-input-and-key-shares distributed oblivious pseudorandom function (DOPRF) protocol to obtain a set of first pseudorandom function (PRF) results, each result corresponding to one of a plurality of elements in a checklist held by a list holder; executing a second committed-input-and-key-shares DOPRF protocol to obtain a second PRF result corresponding to an identity of a prover; and determining whether one of the elements in the checklist corresponds to the identity of the prover based upon the set of first PRF results and the second PRF result.

### CROSS-REFERENCE TO RELATED APPLICATIONS

This application is a U.S. National Phase application under 35 U.S.C. § 371 of International Application No. PCT/IB2023/056617, filed on Jun. 27, 2023, and claims benefit to U.S. Patent Application No. 63/455,276, filed on Mar. 29, 2023, the entire disclosure of which is hereby incorporated by reference herein. The International Application was published in English on Oct. 3, 2024 as WO 2024/201126 A1 under PCT Article 21(2).

### FIELD

Embodiments of the present disclosure relate to a method, system and computer-readable medium for anonymous and unlinkable authentication with membership test via private set intersection (PSI) cardinality.

### BACKGROUND

A self-sovereign identity (SSI) system enables individuals to have full control of their own identities and credentials. Verifiable anonymous credentials (VAC) provide a powerful tool to realize the SSI vision. In a VAC system, a user can obtain credentials from a credential issuer, and can later use these credentials to authenticate to verifiers anonymously. The authentication process is performed peer-to-peer between end-users and verifiers, without the need of involving the credential issuer. Additionally, users remain anonymous to verifiers and are unlinkable across interactions.

The present inventors have recognized that, while VACs have the potential of combining the goals of authentication and privacy in practically relevant use cases, most existing solutions are limited to basic authentication scenarios between users and verifiers.

### SUMMARY

An aspect of the present disclosure provides a computer-implemented method for anonymous credential verification and privacy-preserving membership test. The method includes: executing a first committed-input-and-key-shares distributed oblivious pseudorandom function (DOPRF) protocol to obtain a set of first pseudorandom function (PRF) results, each result corresponding to one of a plurality of elements in a checklist held by a list holder; executing a second committed-input-and-key-shares DOPRF protocol to obtain a second PRF result corresponding to an identity of a prover; and determining whether one of the elements in the checklist corresponds to the identity of the prover based upon the set of first PRF results and the second PRF result.

### BRIEF DESCRIPTION OF THE DRAWINGS

Embodiments of the present disclosure will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 illustrates a system and method of anonymous credential verification and privacy-preserving membership testing according to an embodiment of the present disclosure;

FIG. 2 illustrates a system and method of anonymous credential verification and privacy-preserving membership testing for a three-party case according to an embodiment of the present disclosure;

FIG. 3 illustrates a system and method of anonymous credential verification and privacy-preserving membership testing for a two-party case according to an embodiment of the present disclosure; and

FIG. 4 illustrates a processing system configured according to an embodiment of the present disclosure.

### DETAILED DESCRIPTION

An aspect of the present disclosure provides a method that performs a privacy preserving blacklist or whitelist matching in a self-sovereign identity-based (SSI-based) digital identity system. The matching can be made on any attributes of a users' anonymous credentials. A system configured to perform the method and a computer-readable medium configured to store instructions for executing the method are also provided according to aspects of the present disclosure.

As discussed above, most existing VAC solutions are limited to basic authentication scenarios between users and verifiers. Currently, in the state of the art known to the present inventors, only a single solution is available to enable a private membership test for a VAC holder with respect to a private checklist held by a third party: Kohlweiss et al, “Privacy-preserving blueprints”, Advances in Cryptology (Eurocrypt) 2023, Lecture Notes in Computer Science, vol. 14005, pp. 594-625, 2023, available online at: <<eprint.iacr.org/2022/1536.>> (hereinafter “Kohlweiss”) (the entire contents of which are hereby incorporated by reference herein). Kohlweiss relies on a homomorphic enough cryptosystem to encode the list elements in the coefficients of a polynomial. Instead, implementations according to the present disclosure uses a PRF-based representation of the list elements computed obliviously by means of a DOPRF protocol. As a consequence, if the user is in the checklist, Kohlweiss leaks the identity of the user, thereby violating the privacy of said user. In contrast, implementations of the present disclosure only reveal whether the user's identity belongs to the checklist, which is the minimal leakage needed for a membership test application.

To illustrate this failure, consider a scenario utilizing private blacklist/whitelist matching in an authentication/authorization application, where privacy for verifiers is required. Here, authorities and/or corporations (i.e., the verifiers) may like to screen users against a checklist. In current realizations of user-authentication/authorization, the checklist is held by the verifier or by third parties. The user presents their identity to the verifier, and the verifier locally checks the presented identity against the checklist. The verifier, therefore, needs to inspect the identity of the user. Current realizations of this scenario lack sufficient technical mechanisms to protect the privacy of users. Moreover, if the checklist is held by a third party, the verifier performing a local check also learns all elements in the checklist, thereby violating the privacy of the list holder. Thus, the current realizations also lack sufficient technical mechanism to protect the privacy of the list holder.

Specifically, currently available VAC solutions do not allow for realizing the aforementioned checklist-matching scenario. For example, existing solutions for membership tests, with respect to a verifier-held checklist, require verifiers to disclose their checklist so that users can generate a zero-knowledge proof of membership to the checklist in the case of a whitelist (or non-membership to the checklist in the case of a blacklist). The state of the art VAC methods merely perform a zero-knowledge membership tests on public lists. See, e.g., Benarroch et al., “Zero-Knowledge Proofs for Set Membership: Efficient, Succinct, Modular”, Financial Cryptography and Data Security, Lecture Notes in Computer Science, vol 12674, pp. 393-414, 2021 (the entire contents of which are hereby incorporated by reference herein). This solution is suitable only for use cases where no privacy is required for the verifier's checklist. For example, the verifier runs a membership test to check whether the user is a maintainer of a certain public project (e.g., GitHub-hosted software). Currently, in the state of the art known to the present inventors, no solution is available to enable a private membership test for a VAC holder with respect to a private checklist held by a third party.

Having recognized this failure, the present inventors have designed privacy-preserving authentication mechanisms, implemented according to aspects of the present disclosure, that are adapted for a three-party scenario, where a verifier does not need to have (and may be excluded from having) access to the blacklist/whitelist, but only needs a proof of inclusion or exclusion of the users within the blacklist/whitelist. Privacy-preserving mechanisms adapted for this three-party scenario solve the technical failures of the current state of the art private membership tests.

For example, an embodiment of the present disclosure adapted for the airline domain advantageously incorporates privacy-preserving mechanisms that allow an airline to check travelers according to a sanction list held by the government without leaking any information. Other example use cases can include border control police screening the passengers and vehicles according to “watchlists,” and airlines or hotels checking if the check-in guest is in a “VIP list” without leaking their VIP list to the users. As another example, in some countries, in addition to an “unwelcomed-list,” casinos also have “self-exclusion” program that restricts the admission of certain customers.

According to a first aspect, the present disclosure provides a method that performs a privacy-preserving membership test, on a private list, for the identity associated to a verifiable anonymous credential, enabling a verifier to check whether a user participating in the authentication/authorization process belongs to a checklist held by a list holder.

According to a second aspect, a method for anonymous credential verification and privacy-preserving membership test is provided. The method executes a protocol between a prover holding anonymous verifiable credentials (VAC), a verifier, and a list holder holding a checklist. In the protocol, steps 1-2 check the credentials, while steps 3-7 check the user according to the list, and step 8 provides the connection between these parts and the final output. In particular, the following protocol includes the following steps:
Step 1: Providing, by the prover, a verifiable presentation of her anonymous credentials, a commitment to her identity, and a zero-knowledge proof binding her identity to the credentials.
Step 2: Verifying, by the verifier, the credentials and the zero-knowledge proof.
Step 3: Selecting, by the list holder, a pseud-random function (PRF) key share uniformly at random and committing to it; generating a commitment for each element of the checklist; sending all the commitments to the prover.
Step 4: Selecting, by the prover, a PRF key share uniformly at random, committing to it, and sending it to the list holder.
Step 5: Pseudorandom representation of the checklist: Executing a shuffled distributed oblivious PFF (DOPRF) protocol, with committed key-shares and committed inputs, between the list holder acting as the sender and the prover acting as the receiver, on input the elements of the checklist, and providing the output to the verifier.
Step 6: Pseudorandom representation of the user ID: Executing a DOPRF protocol, with committed key-shares and committed inputs, between the prover acting as the sender and the list holder acting as the receiver, on input the prover's identity, and providing the output to the verifier.
Step 7: Generating, by the prover, a zero-knowledge proof for input consistency of the committed value used in the credential verification protocol from Step 1 and the committed value used in the DOPRF protocol from Step 6.
Step 8: Verifying, by the verifier, the zero-knowledge proof of input consistency provided by the prover, and finally authenticating the user if all protocol steps succeed.

According to a third aspect, the present disclosure provides a method that comprises at least one of:
Binding the user's anonymous credentials to the privacy-preserving membership test through commitments and zero knowledge proofs to ensure the user uses the correct attributes of their identity in the membership test;
Enabling a three-party privacy-preserving membership test on user identities within verifiable anonymous credentials by means of a private set intersection (PSI) cardinality protocol; and/or
Providing unlinkability of users in a privacy-preserving membership test on user identities by means of a shuffled distributed OPRF protocol.

According to a fourth aspect of the present disclosure, a computer-implemented method for anonymous credential verification and privacy-preserving membership test is provided. This method includes: executing a first committed-input-and-key-shares distributed oblivious pseudorandom function (DOPRF) protocol to obtain a set of first pseudorandom function (PRF) results, each result corresponding to one of a plurality of elements in a checklist held by a list holder; executing a second committed-input-and-key-shares DOPRF protocol to obtain a second PRF result corresponding to an identity of a prover; and determining whether one of the elements in the checklist corresponds to the identity of the prover based upon the set of first PRF results and the second PRF result.

According to a first implementation of the method of the fourth aspect of the present disclosure, the first committed-input-and-key-shares DOPRF protocol is a shuffled committed-input-&-key-shares DOPRF protocol, and the set of first PRF results are shuffled as compared to an order of the elements in the checklist to provide a pseudorandom representation of the checklist.

According to a second implementation, the method of the fourth aspect according to any of the above implementations may further include: receiving, from the prover, a first commitment to the identity of the prover, a first zero-knowledge proof (ZKP) binding the identity of the prover to verifiable anonymous credentials (VAC) of the prover; and at least one of a pseudonym of the identity or a corresponding credentials, the VAC comprising the identity, the pseudonym, and the credentials; and verifying that the first ZKP is valid; and verifying the credentials.

According to a third implementation, in the method of the fourth aspect according to any of the above implementations, the inputs to the first committed-input-and-key-shares DOPRF protocol may include: a first pseudorandom function (PRF) key share of the prover; a first commitment corresponding to a second PRF key share of the list holder; the second PRF key share of the list holder; a set of commitments corresponding to the elements in the checklist; a second commitment corresponding to the PRF key share of the prover; and the checklist. The set of first PRF results may also include values of a pseudorandom function evaluated on the plurality of elements of the checklist, using the first PRF key share and the second PRF key share.

According to a fourth implementation, in the method of the fourth aspect according to any of the above implementations, the inputs to the second committed-input-and-key-shares DOPRF protocol may include: a first pseudorandom function (PRF) key share of the prover, a first commitment corresponding to a second PRF key share of the list holder, the identity of the prover; the second PRF key share of the list holder, and a second commitment corresponding to the first PRF key share of the prover. Also, the second PRF result may include a value of the pseudorandom function evaluated on the identity of the user, using the first PRF key share and the second PRF key share.

According to a fifth implementation, in the method of the fourth aspect according to any of the above implementations, executing the second committed-input-and-key-shares DOPRF protocol further obtains a third commitment to the identity of the prover.

According to a sixth implementation, the method of the fourth aspect according to any of the above implementations further includes, at a verifier, before executing the first committed-input-and-key-shares DOPRF protocol and the second committed-input-and-key-shares DOPRF protocol: receiving, from the list holder, a commitment to a first pseudorandom function (PRF) key share, commitments to the plurality of elements of the checklist, and a zero-knowledge proof (ZKP) that the checklist supplied for the first DOPRF protocol is consistent with the commitments to the plurality of elements of the checklist, and sending the commitment to the first PRF key share, the commitments to the plurality of elements of the checklist, and the ZKP to the prover; and receiving, from the prover, a commitment to a second PRF key share, and sending the commitment to the second PRF key share to the list holder. Also, in this implementation, the first PRF key share was selected uniformly at random by the list holder, and the second PRF key share was selected uniformly at random by the prover.

According to a seventh implementation, the method of the fourth aspect according to any of the above implementations further includes, at the verifier, after executing the first committed-input-and-key-shares DOPRF protocol and the second committed-input-and-key-shares DOPRF protocol: receiving, from the prover, a second ZKP of a consistency between the first commitment to the identity of the prover and a second commitment to the identity of the prover from in the second committed-input-and-key-shares DOPRF protocol; and verifying the second ZKP.

According to a seventh implementation, in the method of the fourth aspect according to any of the above implementations, the checklist is a whitelist. In this implementation, the method further includes: upon determining that the identity of the prover belongs to one of the plurality of elements of the checklist and upon verifying that the second ZKP is valid, authenticating the prover.

According to an eighth implementation, in the method of the fourth aspect according to any of the above implementations, the checklist is a blacklist In this implementation, the method further includes: upon determining that the identity of the prover does not correspond to any of the plurality of elements of the checklist and upon verifying that the second ZKP is valid, authenticating the prover.

According to a ninth implementation, in the method of the fourth aspect according to any of the above implementations, the verifier executes the first committed-input-and-key-shares DOPRF protocol, executes the second committed-input-and-key-shares DOPRF protocol, and determines whether one of the elements in the checklist corresponds to the identity of the prover.

According to a tenth implementation, in the method of the fourth aspect according to any of the above implementations, the verifier and the list holder coincide on a same computer.

According to an eleventh implementation, in the method of the fourth aspect according to any of the above implementations, the determining whether one of the elements in the checklist corresponds to the identity of the prover comprises determining whether a value of a pseudorandom function evaluated on the identity of the prover matches with any values of the pseudorandom function evaluated on the plurality of elements of the checklist.

According to a fifth aspect, a computer system is provided. The computer system of this aspect includes one or more hardware processors which, alone or in combination, are configured to provide for execution the method according to each of the above aspects and their implementations.

According to a sixth aspect, a tangible, non-transitory computer-readable medium is provided. The computer-readable medium of this aspect has instructions thereon which, upon being executed by one or more hardware processors, alone or in combination, provide for execution the methods according to each of the above aspects and their implementations.

Aspects of the present disclosure provide a multiplicity of technical improvements to the functionality of authentication systems, particularly VAC systems. For example, aspects of the present disclosure provide a privacy-preserving mechanism implemented as a combination of a PSI cardinality protocol with verifiable anonymous credentials, which provides unlinkability. Further, aspects of the present disclosure provide privacy-preserving mechanisms that: include a separation of the membership-verifying and credential-holding tasks; enable privacy-preserving checklist matching for SSI systems for a three-party scenario; and/or support checklist matching for non-public checklists. Authentication systems currently available in the field, do not include at least the above-listed functionality enabled by aspects of the present disclosure. Aspects of the present disclosure are capable of implementing such privacy-preserving mechanisms in an automated way, which is amenable to being implemented at scale, with an efficient use of computer resources.

The present disclosure therefore provides an improved VAC system for privacy-preserving checking of membership in a set (e.g., checklist) as compared to the state-of-the-art. For example, the present disclosure represents an improvement over a proposal by Miao for a PSI cardinality protocol based on shuffled committed input and key shares. See Miao, Peihan, Sarvar Patel, Mariana Raykova, Kam Seth, and Moti Yung, “Two-Sided Malicious Security for Private Intersection-Sum with Cardinality,” CRYPTO 2020, pp. 1-50, 2020, available online at: <<eprint.iacr.org/2020/385.>> (hereinafter “Miao”) (the entire contents of which are hereby incorporated by reference herein). Unlike aspects of the present disclosure, Miao does not provide for a combination of a PSI cardinality protocol with verifiable anonymous credentials, much less a combination that provides unlinkability. Also different from aspects of the present disclosure, Miao does not include a distribution among entities of the verification and credential holding tasks.

Aspects of the present disclosure instantiate one or more cryptographic building blocks to realize the privacy-preserving mechanism used as part of performing the membership test. Exemplary building blocks used in embodiments implemented according to aspects of the present disclosure are defined below.

### SSI System

In a self-sovereign identity (SSI) system, users control and own their digital identities and other verifiable anonymous credentials (VAC) without having to rely on a central authority. They are therefore completely independent of third parties and decide independently who is provided with which identity data.

There may be three actors involved in an SSI system that interact collectively with the SSI. These actors are: issuers, verifiers, and owners. Issuers issue verifiable digital credentials, such as certificates of identity, endorsements, proficiency, authorizations, qualifications or membership cards. Exhibitors are companies or organizations that are authorized to issue digital proofs, such as registration offices, road traffic offices, schools and universities, professional associations, authorities or qualification and testing organizations. Verifiers are points of acceptance or applications that use digital evidence for their processes. Owners, also referred to as users or provers, are holders of digital evidence. An owner or user usually has a corresponding SSI-enabled app on their mobile device with a digital wallet, in which the verifiable digital evidence can be securely stored. In some embodiments, an issuer may also act as a verifier. In such a case, only two actors are involved in the SSI system.

### Verifiable Anonymous Credentials (VAC)

In a VAC system, a user u (also referred to as a prover or owner) obtains credentials (u, cred) signed by an authority (referred to as an issuer), and can later present these credentials to other authorities/organizations (referred to as verifiers). Verifiability ensures that a prover holding valid credentials can convince a verifier that her credentials were issued by the relevant authority. In an anonymous credential system, a prover can additionally authenticate to verifiers using one-time pseudonyms (nym) rather than the identity, so that the presentation of credentials (nym, cred) only reveal possession of specific attributes, while it reveals nothing about the identity (u) of the prover.

The present disclosure is not limited to a specific implementation of a credential-issuing/obtaining protocol, but instead can implement such a protocol as appropriate for the application scenario. Nevertheless, the credential-issuing protocol can include the following two steps: 1) the issuer validates the attributes for which the user requested a verifiable credential; and 2) the issuer digitally signs (a representation of) these attributes. Thus, a pair (m, σ), where the message m is a representation of the attributes, and σ is a digital signature on m (generated by the issuer using its signing key), provides a verifiable credential to the user. Since a digital signature is publicly verifiable, being in possession of (m, σ) allows the user to convince anybody that the issuer truly signed the statement.

For example, a citizen of a certain country could request the government to attest their nationality. In this case, a government agent would function as the issuer by checking the user's passport (or any other document stating the nationality of the user) and then digitally signing a statement m claiming that the digital identity of that user is associated to the claimed nationality. The user can then present the government-agent signature to prove their nationality to any verifier, who can validate the signature under the government verification key (which is public), without the need of disclosing the user's password.

Similarly, the present disclosure is not limited to a specific implementation of a pseudonym-issuing/obtaining protocol, but instead can implement such a protocol as appropriate for the application scenario. For example, pseudonyms can be chosen by the user, or can be computed as cryptographic commitments of a user-held secret key. See, e.g., Jan Camenisch, “Concepts Around Privacy-Preserving Attribute-Based Credentials—Making Authentication with Anonymous Credentials Practical,” Privacy and Identity Management for Emerging Services and Technologies, pp. 53-63, 2014, available online at: <<hal.science/hal-01276046/document>> (hereinafter “Camenisch”) (the entire contents of which are hereby incorporated by reference herein).

### Zero-Knowledge Proof (ZKP)

In cryptography, a zero-knowledge proof or zero-knowledge protocol is a method by which one party (the prover) can prove to another party (the verifier) that a given statement is true while the prover avoids conveying any additional information apart from the fact that the statement is indeed true. See Camenisch.

### Oblivious Pseudorandom Function (OPRF) Protocols

An oblivious pseudorandom function (OPRF) protocol is an interactive protocol allowing two parties to evaluate a pseudorandom function (PRF) on an input x provided by one party, and under a key K (referred to as a PRF key) provided by other party. The protocol is oblivious in the sense that the sender (input holder) obtains the output F_{K}(x) and learns nothing about the PRF key, while the receiver (key holder) receives no output and learns nothing about the sender's input. For instance, consider the Dodis-Yampolskiy (DY) pseudorandom function, defined by:

$${f}_{k}^{D Y} ( x ) := {g}^{1 / ( k + x )} ,$$

where g is a generator of a cyclic group [symbol] := [symbol] g [symbol] of prime order q∈ [symbol] , and x, k∈ [symbol] _{q}. It is known that the DY pseudorandom function can be obliviously evaluated using additively homomorphic encryption (e.g., via Paillier encryption scheme). See Yevgeniy Dodis, “A Verifiable Random Function with Short Proofs and Keys,” IACR 8th International Workshop on Theory and Practice in Public Key Cryptography (PKC 2005), pp. 416-431, available online at <<eprint.iacr.org/2004/310.pdf>>. An OPRF protocol for evaluating the Dodis-Yampolskiy (DY) pseudorandom function f^{DY} is described below.
Oblivious evaluation protocol for the Dodis-Yampolskiy PRF (※):

Setup: The input holder has an input x∈ [symbol] _{q} and the key holder picks a PRF key k← [symbol] _{q}. The key holder additionally generates a key pair (sk,pk)←HE.Gen for the homomorphic encryption scheme, and shares the public key pk with the input holder.

Step 1: The key holder homomorphically encrypts the PRF key, obtaining a ciphertext c₁←HE.Encₚₖ(k), and sends c₁ to the input holder.

Step 2: After receiving ciphertext c₁, the input holder picks an element r∈ [symbol] _{q} uniformly at random, homomorphically encrypts input x to obtain a ciphertext c′←HE.Encₚₖ(x), computes c₂←(c₁·c′)^{r}, and finally sends ciphertext c₂ to the key holder.

Step 3: After receiving ciphertext c₂, the key holder decrypts to obtain a message m, computes y′←g^{1/m}, and sends y′ to the input holder.

Step 4: After receiving y′, the input holder computes y←(y′)^{r} and outputs this value.

Because of the properties of the homomorphic encryption scheme, the aforementioned OPRF protocol allows the input holder to correctly compute the PRF evaluation of x. Indeed, the key holder decrypts c₂ as follows:

$$HE . {Dec}_{s k} ( {( HE . {Enc}_{p k} ( x ) \cdot HE . {Enc}_{p k ( k )} )}^{r} ) = HE . De {c}_{s k} ( HE . {Enc}_{p k} ( r ( x + k ) ) ) = r ( x + k ) ,$$

$$thus :$$

$${( {y}^{′} )}^{r} = {( {g}^{1 / m} )}^{r} = {g}^{\frac{r}{r ( x + k )}} = {g}^{\frac{1}{( x + k )}} = {f}_{k}^{D Y} ( x ) .$$

See Casacuberta, Silvia, Julia Hesse, and Anja Lehmann, “SoK: Oblivious Pseudorandom Functions,” 2022 IEEE 7th European Symposium on Security and Privacy, pp. 625-646, 2022, available online at: <<eprint.iacr.org/2022/302.pdf>> (hereinafter “Casacuberta”) (the entire contents of which are hereby incorporated by reference herein).

### Distributed, Oblivious Pseudorandom Function (DOPRF) Protocols

An OPRF variant, called “distributed” OPRF (DOPRF), allows both parties to contribute the key and obtain the PRF evaluation. In a DOPRF protocol, the input holder (henceforth referred to as the sender) provides the input x and a key share k_{S}, the other party (henceforth referred to as the receiver) provides a key share k_{R}, and both parties learn Fₖ_{_{S}}_{,k}_{_{R}}(x). As the PRF key is now contributed by both parties, the PRF evaluation Fₖ_{_{S}}_{,k}_{_{R}}(x) reveals no information about x to the receiver due to the pseudo-randomness property. See Miao. A distributed OPRF protocol for the evaluation of the PRF fₖ_{_{S}}ₖ_{_{R}}(x): =g^{1/(k}^{_{S}}^{+k}^{_{R}}^{+x)}, i.e., the DY pseudorandom function

$${f}_{k}^{DY} ( x ) := {g}^{1 / ( k + x )}$$

with key k=k_{S}+k_{R}, can be obtained from the OPRF protocol (※) by letting the sender contribute the PRF key share k_{S}.

More specifically, the following modification of protocol (※) provides a DOPRF protocol for the DY pseudorandom function:

Setup: The sender has an input x∈ [symbol] _{q} and a PRF key share k_{S}∈ [symbol] _{q}. The receiver holds a PRF key share k_{R}∈ [symbol] _{q} and generates a key pair (sk,pk)←HE. Gen for the homomorphic encryption scheme. The receiver sends the encryption key pk to the sender.

Step 1: The receiver homomorphically encrypts its PRF key share k_{R}, obtaining a ciphertext c₁←HE.Encₚₖ(k_{R}), and sends c₁ to the sender.

Step 2: After receiving ciphertext c₁, the sender picks an element r∈ [symbol] _{q} uniformly at random, homomorphically encrypts input x+k_{S} to obtain a ciphertext c′←HE.Encₚₖ(x+k_{S}), computes c₂←(c₁·c′)^{r}, and finally sends ciphertext c₂ to the receiver.

Step 3: After receiving ciphertext c₂, the receiver decrypts it to obtain a message m, computes y′←g^{1/m}, and sends y′ to the sender.

Step 4: After receiving y′, the sender computes y←(y′)^{r}, sends y to the receiver, and outputs y.

### Committed-Input OPRF Protocols

A committed-input OPRF protocol provides the same functionality of an OPRF and, additionally, it makes the sender commit to its input. This provides the possibility to verify that the same input is used in multiple runs of the protocol or in a combination of protocols. Such protocols can be instantiated by letting the sender commit to its input and proving in zero-knowledge that the input to the OPRF protocol is the same value the sender has committed to.

The OPRF protocol (※) can be turned into one with committed input by letting the sender include to the message sent in Step 2 a cryptographic commitment cₓ←com(x;rₓ), where rₓ is the randomness of the commitment. To make the protocol secure against malicious adversaries, the sender should also include a zero-knowledge proof stating that it correctly computed ciphertexts c′ and c₂ (in particular, that c′ is an encryption of the value committed to in cₓ). A suitable commitment scheme to be used in the oblivious evaluation of f^{DY} is the Pedersen commitment.

### Committed-Key-Shares DOPRF Protocols

Analogous to committed-input OPRF protocols, a committed-key-share DOPRF protocol forces either the sender or the receiver, or both, to commit to the key share they use in the DOPRF protocol. This allows to check that the same key-share is used in multiple runs of protocols. Similar to committed-input OPRF protocols, committed-key-shares DOPRF protocols can be instantiated via commitment schemes and zero-knowledge proofs. The DOPRF protocol (※) can be turned into one with committed key shares by letting the sender and receiver include a cryptographic commitment cₛ resp. cᵣ to its key share kₛ resp. kᵣ, i.e., cₛ←com(kₛ;rₛ) for some random value rₛ. A suitable commitment scheme to be used in the oblivious evaluation of f^{DY} is Pedersen commitment. To obtain security against a possibly malicious sender, the protocol shall include an additional value sent in any step in which the sender resp. receiver provides a zero-knowledge proof to convince the receiver resp. sender that the current intermediate result corresponds to the evaluation prescribed by the protocol for the current step with the committed key share used as input. See Miao.

### Committed-Input-&-Key-Shares DOPRF Protocols

The committed-input OPRF protocol and the committed-key-share DOPRF protocol can be combined, so that each party commits to its key share and additionally the sender commits to its input. Concretely, the OPRF protocol (※) can be turned into a committed-input-&-key-shares DOPRF protocol by including all the previously mentioned modifications. The previously included commitments and zero-knowledge proofs do not influence each other. See Miao.

### Shuffled DOPRF Protocols

A shuffled DOPRF protocol allows the sender and the receiver to run a DOPRF protocol on a sequence of inputs provided by the sender, so that they obtain the PRF evaluations of these inputs in a random order. In this way, the sender cannot associate her inputs to the corresponding output values. The DOPRF protocol (※) can be turned into a shuffled one by doing the evaluations for multiple xᵢ in each step and letting the sender send the intermediate results c₂ for the xᵢ in step 2 in a random order instead of ordered by the i index of the corresponding xᵢ. See Miao.

### Private Set Intersection Cardinality (PSI Cardinality)

A PSI cardinality protocol is an interactive protocol allowing two parties, A and B, to jointly and privately compute the cardinality of the intersection of input sets S_{A} held by party A and S_{B} held by party B. The term “privately” refers to the fact that both parties do not learn anything more than the cardinality of the intersection of their sets and the cardinality of the sets. In particular, party A does not gain any information about the content of input set S_{B}, and party B does not gain any information about the content of input S_{A}. See Miao. PSI cardinality protocols can provide security against malicious parties, who may deviate arbitrarily from the protocol.

A PSI cardinality protocol can be implemented using committed-input-&-key-shares OPRFs. See Miao. In some embodiments, the same pseudorandom transformation Fₖ(⋅), computed obliviously by means of an OPRF protocol, is applied to A's input aᵢ∈S_{A} and to B's input bᵢ∈S_{B}. Then, the number of intersection elements is obliviously calculated by building the intersection of the pseudorandomly transformed elements.

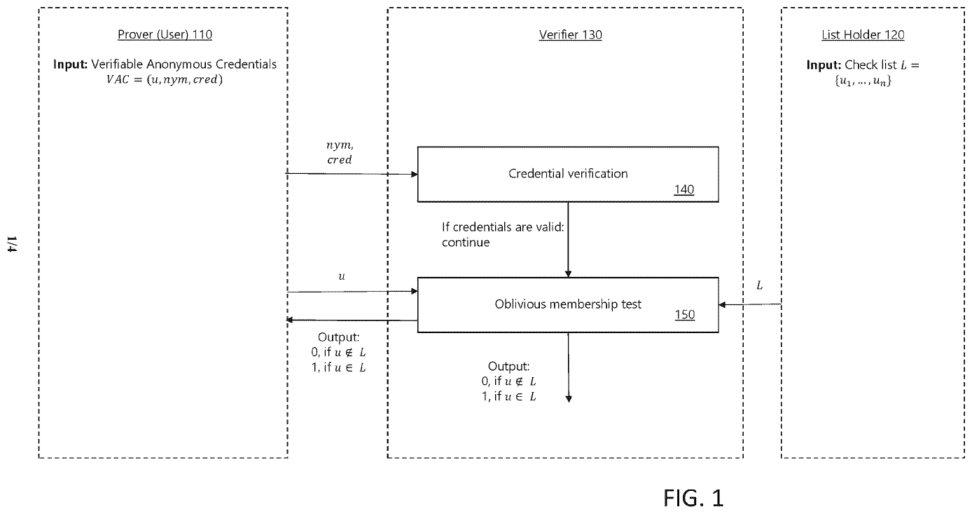

FIG. 1 illustrates a system and method of anonymous credential verification and privacy-preserving membership testing implemented according to an aspect of the present disclosure. Three entities may be involved in the system: a prover (also referred to as user) 110, a list holder 120, and a verifier 130. The prover 110 wishes to authenticate to a verifier 130 (e.g., an authority) by proving possession of valid credentials in a privacy-preserving manner. The verifier 130 wishes to check whether the prover's identity (which is not disclosed to the verifier 130) belongs to a checklist (e.g., whitelist, blacklist, etc.) held by a third-party list holder 120 (e.g., another authority). The membership test is “privacy preserving” in the sense that the prover's identity is not disclosed to the verifier 130 and the list holder 120, and similarly the list holder's checklist is not disclosed to any other party.

Referring to FIG. 1, the prover 110 holds verifiable anonymous credentials VAC=(u, nym, cred), where u denotes the prover's identity, nym denotes a one-time pseudonym of the prover's identity, and cred denotes the corresponding credential. At 140, the prover 110 presents the anonymous credentials (nym, cred) to the verifier 130. The verifier 130 verifies whether the credentials are valid by determining whether the credentials satisfy a certain public policy, i.e., validating a relation function Rel_{VAC}(u, nym, cred). Upon verifying that the prover's credentials are valid, at 150, the verifier 130 performs an oblivious membership test to check whether the prover's identity u (which is not disclosed to the verifier 130) belongs to a checklist L={u₁, . . . , uₙ} held by the list holder 120 (also not disclosed to the verifier 130). If the prover 110 belongs to the checklist L (u∈L), the output would be 1; if the prover 110 does not belong to the checklist L (u∉L), the output would be 0. The checklist L, as indicated in FIG. 1, may be provided as a set of user identities u₁, . . . , uₙ that share a common quality.

The present disclosure is not limited to a specific relation function, and may be adapted based on the application as a person of ordinary skill in the art would readily be able to implement. It is noted that the verifier does not directly evaluate the predicate (i.e., by evaluating the expression on input (u,nym,cred), but instead engages in an anonymous credential verification protocol with the user. Anonymous credentials allow the user to prove possession of credentials fulfilling a certain relation without revealing all sensitive data described in the credentials.

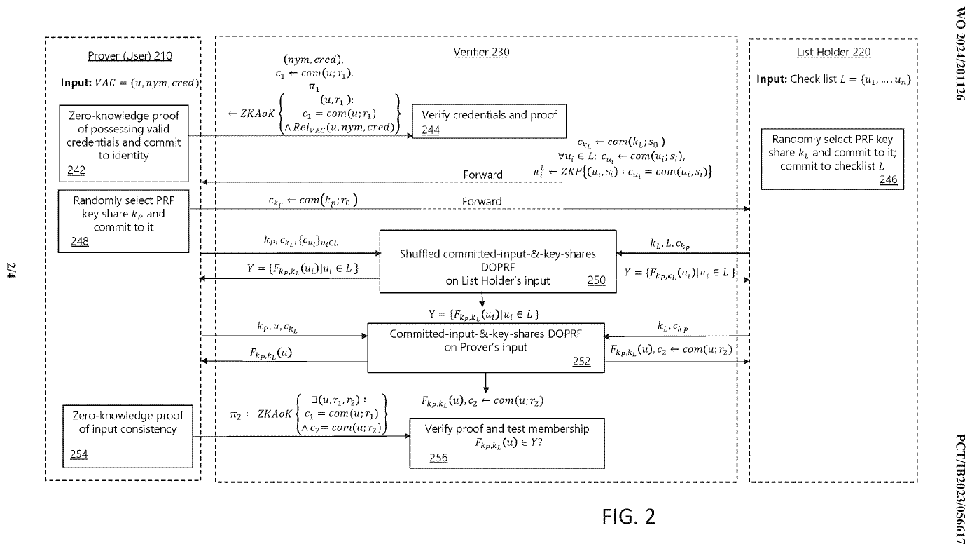

The oblivious membership test 150 may execute a PSI cardinality protocol. The PSI cardinality protocol allows the prover 110 and verifier 120 to jointly and privately determine if the prover's identity u belongs to the checklist L={u₁, . . . , uₙ}. Because this protocol is privacy preserving, neither the verifier 130 nor the list holder 120 learns the prover's identity u, and neither the verifier 130 nor the prover 110 learns the checklist L={u₁, . . . , uₙ}. All that the entities learn is the cardinality of the intersection of their sets, i.e., how many entries (elements) are shared between the sets, and the cardinality of the sets, i.e., the number of entries in each set. In the present example, because the prover's set consists of 1 entry—i.e., the prover's identity u—the cardinality of the intersection will be either 1 or 0. With 1 indicating that the prover 110 belongs to the checklist L. The PSI cardinality protocol may be implemented, for example, based on a shuffled committed-input and key shares DOPRFs. See, e.g., Miao. The system and method illustrated in FIG. 2 is an exemplary embodiment implementing such a PSI cardinality protocol.

Specifically, FIG. 2 illustrates a system and method of anonymous credential verification and privacy-preserving membership testing according to an implementation of aspects of the present disclosure. Three entities may be included in the system: a prover (or user) 210, a list holder 220, and a verifier 230. An oblivious membership test is realized by letting the prover 210, the verifier 230, and the list holder 220 operate a joint protocol.

In the joint protocol, first, the prover 210 and the verifier 230 engage in an anonymous credential sub-protocol (operations 242 and 244, discussed below); then, the prover 210 and the list holder 220 run a PSI cardinality sub-protocol with the aid of the verifier 230 (operations 246, 248, 250, 252, 254, and 256, discussed below).

In the PSI cardinality sub-protocol, the prover 210 and the list holder 220 generate and contribute their own key material. The prover 210 provides its identity u as input, while the list holder 220 provides its list L as input. The protocol terminates with prover 210 and the verifier 230 obtaining only the single information of whether the prover's identity is in the list. In the example of FIG. 2, the list holder 220 does not obtain the outcome. However, in other embodiments, the output may be provided to the list holder.

For the protocol to be secure, the prover 210 submits the same identity u as input to both the VAC sub-protocol and the PSI cardinality sub-protocol. To this end, the two sub-protocols are cryptographically bound by letting the prover 210 commit to its identity first, and later prove in zero-knowledge that the input to the PSI cardinality protocol coincides with the previously committed value.

Referring to FIG. 2, in the anonymous credential sub-protocol, at 242, the prover 210 presents its verifiable anonymous credentials (VAC) (nym, cred) to the verifier 230, along with a commitment to its identity c₁←com(u; r₁), for a random value r₁, as well as a first zero-knowledge proof (ZKP) π₁ of possessing valid credentials and binding the committed identity to the VAC (the ← operator indicates an assignment). More precisely, the prover computes a zero-knowledge argument of knowledge (ZKAoK) for values u (the alleged identity) and r₁ (the commitment's randomness) such that c₁ is a commitment to value u using randomness r₁, and value u along with the VAC (nym, cred) fulfils the desired relation:

$${π}_{1} ← ZKAoK \{ \begin{matrix}( u , {r}_{1} ) : \\ {c}_{1} = com ( u ; {r}_{1} ) \\ ∧ {Rel}_{VAC} ( u , nym , cred )\end{matrix} \} .$$

The prover's anonymous credentials may include both the user's pseudonym nym and corresponding credential cred, which are one-time representations and not linkable in multiple showings of the VAC. At 244, the verifier 230 verifies whether the VAC and the first ZKP π₁ presented by the prover 210 are valid.

After verifying the VAC and the first ZKP π₁, the verifier 230 contacts the list holder 220 to engage in the PSI cardinality sub-protocol. The PSI cardinality sub-protocol is executed between the prover 210 and the list holder 220, which communicate with each other by passing all messages to the verifier 230, which may forward all messages except for the final output.

To ensure that the PRF values reveal no information about their corresponding inputs, each entity contributes a share of the PRF key K=k_{P}∘k_{L}, where the key share k_{P} is contributed by the prover 210, and the key share k_{L} is contributed by the list holder 220. This can be instantiated using a distributed OPRF (DOPRF) protocol.

To further protect against a potentially malicious prover or list holder, who may deviate from the protocol to bypass the membership test or to learn more information about the other party's input, both parties commit to their key shares and to their inputs and prove in zero-knowledge that all supplied inputs are consistent with the corresponding commitments. This can be instantiated via committed-input and committed-key-shares DOPRFs.

Referring to FIG. 2, at 246, the list holder 220 randomly selects a pseudorandom function (PRF) key share k_{L}, and commits to it

cₖ_{_{L}}←com(k_{L};s₀),

where s₀ is the randomness for the commitment). The commitment function used here may be the same as used in the anonymous credential sub-protocol, but is not so limited. The list holder 220 also commits to each element of the checklist L (∀uᵢ∈L: cᵤ_{ᵢ}←com(uᵢ;sᵢ)). The message, including

cₖ_{_{L}},L(∀uᵢ∈L:cᵤ_{ᵢ}←com(uᵢ;sᵢ), where sᵢ is the randomness for each commitment cᵤ_{ᵢ}),

and a ZKP πᵢ^{L} for each commitment cᵤ_{ᵢ} proving knowledge of value uᵢ and randomness sᵢ such that cᵤ_{ᵢ}=com(uᵢ, sᵢ):

$${π}_{i}^{L} ← ZKAoK \{ ( {u}_{i} , {s}_{i} ) : {c}_{{u}_{i}} = com ( {u}_{i} , si ) \} ,$$

is forwarded to the prover 210 via the verifier 230. In the above, there is one commitment per element of the checklist.

At 248, the prover 210 randomly selects a PRF key share k_{P}, and commits to it (cₖ_{_{P}}←com(kₚ;r₀), where r₀ is the randomness for the commitment). The commit cₖ_{_{P}}, is forwarded to the list holder 220 via the verifier 230. Thus, the committed value (key share kₚ) is confidential to the Prover, while the resulting commitment cₖ_{_{P}} is forwarded to the Verifier so that it can later verify that the Prover did use the same key share as specified in the supplied commitments.

The PSI cardinality sub-protocol may be realized by letting the prover 210 and the list holder 220 engage in two oblivious pseudorandom function (OPRF) protocols (as discussed below with respect to steps 250 and 252), run in reverse directions, to evaluate the same pseudorandom function (PRF) transformation F_{K}(⋅) on the elements uᵢ of the list L and on the prover's identity u, respectively.

Referring to FIG. 2, at 250, the list holder 220 inputs to the OPRF: the checklist L, its PRF key share k_{L}, and the commit cₖ_{_{P}} for the prover's PRF key share kₚ. The prover 210 inputs to the OPRF: its key share k_{P}, the commit cₖ_{_{L}} for the list holder's key share k_{L}, and the commit {cᵤ_{ᵢ}}ᵤ_{ᵢ}_{∈L} for each of the entries {u₁, . . . , uₙ} in the list L. In the embodiment of FIG. 2, the OPRF is specifically a shuffled committed-input-&-key-shares DOPRF. The shuffled DOPRF protocol ensures that, in the case that the identity u of the prover is in the checklist L (i.e., u∈L), the list holder 220 is prevented from learning which element of the list corresponds to the prover's identity, as the PRF values output at step 250 are shuffled. The output of the DOPRF can be expressed as:

$$Y = \{ {F}_{{k}_{P} , {k}_{L}} ( {u}_{i} ) \vert {u}_{i} ∈ L \}$$

where the output Y is the set of the results of the DOPRF evaluation Fₖ_{_{P}}_{,k}_{_{L}}(uᵢ) run based on the entries in the checklist L and the key shares k_{P}, k_{L}, with one entry in the results set for each entry uᵢ in the checklist L. The order of the set, however, is shuffled as compared to the checklist order. The output Y may be provided to both the prover 210 and the list holder 220.

At 252, the list holder 220 inputs to an OPRF: its key share k_{L} and the commit cₖ_{_{P}} of the prover's key share k_{P}. The prover 210 inputs to the OPRF: its key share k_{P}, its identity u, and the commit cₖ_{_{L}} of the list holder's key share k_{L}. In the example of FIG. 2, the OPRF executed in 252 is a committed-input-&-key-shares DOPRF.

As a result of 252, both the prover 210 and the list holder 220 receive the result of the DOPRF evaluation Fₖ_{_{P}}_{,k}_{_{L}}(u) executed on the identity u of the prover 210 and using the two key shares k_{P}, k_{L}. The list holder 220 may additionally receive a commitment c₂←com(u;r₂), where r₂ is the randomness for the commitment, that the corresponding identity used for the DOPRF evaluation is the identity u of the prover 210.

At 254, the prover 210 provides a ZKP of input consistency π₂ to the proof verification and membership step evaluator of the verifier 230, proving that the two committed inputs represented by commitments c₁ and c₂ are the same:

$${π}_{2} ← ZKP \{ \begin{matrix}∃ ( u , {r}_{1} , {r}_{2} ) : \\ {c}_{1} = com ( u ; {r}_{1} ) \\ ∧ {c}_{2} = com ( u ; {r}_{2} )\end{matrix} \} .$$

At 256, the verifier 230 verifies the ZKP of input consistency π₂, which if verified, indicates that the identity u of the prover 210 was consistently provided in the prior operations. If the ZKP π₂ is verified, the verifier 230 will determine whether the identity u of the prover 210 is in the checklist L. In particular, the verifier 230 does this in a privacy preserving way by determining, by direct comparison, whether Fₖ_{_{P}}_{,k}_{_{L}}(u) belongs to one of the elements in Y={Fₖ_{_{P}}_{,k}_{_{L}}(uᵢ)|uᵢ∈L}. If the answer is yes, the membership test is passed in the case of a whitelist or failed in the case of blacklist. Depending on the implementation, it may be that only the prover 210 receives the result. The specific verification algorithm depends on the ZKP used, however, a feature of a preferred algorithm includes the following: Upon verifying proof π₂, the verifier 230 learns that the input to which the prover 210 committed to in the credential verification protocol, and the input to which the prover 210 committed to in the membership test, are the same. Therefore, since the credential verification protocol binds the committed input in c₁ to the credentials claimed by the prover 210, at this point the verifier 230 is convinced that the identity checked in the membership test is the same identity for which valid credentials have been supplied.

The protocol provides security (more specifically, soundness) in the sense that only provers 210 in possession of valid credentials and who pass the membership test can be authenticated. It also provides privacy for provers and list holders: namely, it prevents the verifier 230 and the list holder 220 from learning the identity u of the prover 210, and it prevents the prover 210 and the verifier 230 from learning the list L held by the list holder 220. The protocol additionally provides unlinkability of provers, meaning that the verifier 230 cannot link multiple authentication requests from the same prover 210, as long as the communication channel between the prover 210 and the verifier 230 is anonymous.

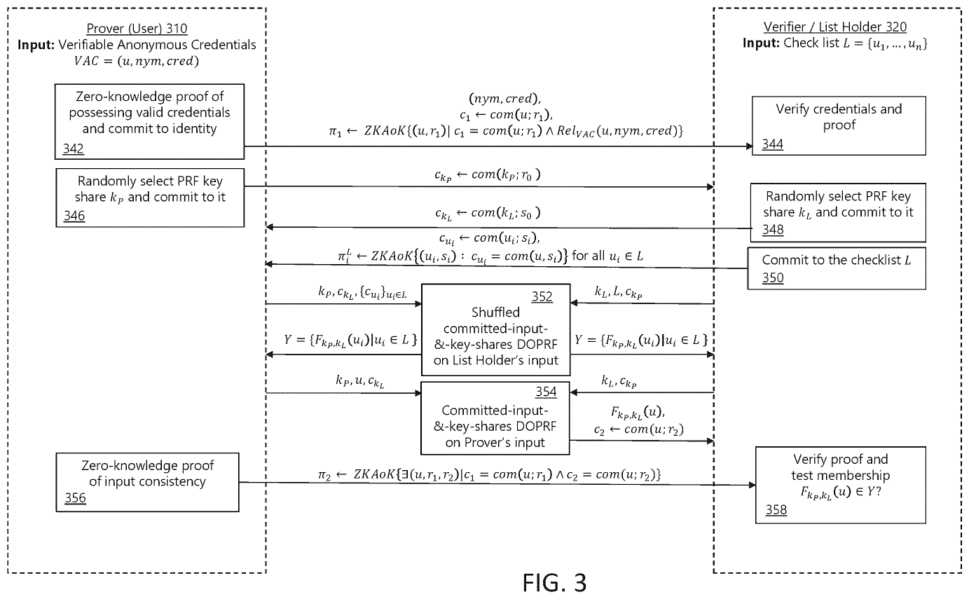

FIG. 3 illustrates a system method of anonymous credential verification and privacy-preserving membership test according to an implementation of aspects of the present disclosure. Here, in contrast to FIG. 2, the roles of verifier and list holder coincide. Thus, two entities may be involved in the process: a prover (or user) 310, and a verifier/list holder 320. A two-party protocol can be obtained by modifying the three-party protocol to let the verifier participate in the PSI cardinality sub-protocol.

At 342, the prover 310 presents its verifiable anonymous credentials (VAC) to the verifier/list holder 320, along with a commitment c₁ to its identity u (i. e., c₁←com(u;r₁)), and a first ZKP π₁ binding the committed identity to the VAC, proving that the (private) identity u associated to the VAC is the same value the prover committed to in commitment c₁:

$${π}_{1} ← ZKAoK \{ ( u , {r}_{1} ) \vert {c}_{1} = c o m ( u ; {r}_{1} ) ∧ {Rel}_{VAC} ( u , nym , cred ) \} .$$

The prover's anonymous credentials may include both a pseudonym nym and a corresponding credential cred, which are one-time representations and not linkable in multiple showings of the VAC.

At 344, the verifier/list holder 320 verifies that the VAC and the first ZKP π₁ presented by the prover 310 are valid. If they are valid, the protocol continues.

After verifying the VAC and the first ZKP, at 346, the prover 310 randomly selects a pseudorandom function (PRF) key share k_{P}, and commits to it (cₖ_{_{P}}←com(kₚ;r₀)). The commit cₖ_{_{P}} is forwarded to the verifier/list holder 320. At 348, the verifier/list holder 320 randomly selects a PRF key share k_{L}, and commits to it (cₖ_{_{L}}←com(k_{L};s₀)). The commit cₖ_{_{L}} is forwarded to the prover 310.

At 350, the verifier/list holder 320 commits to the checklist L (∀uᵢ∈L: cᵤ_{ᵢ}←com(uᵢ;sᵢ)), and provides a ZKP that supplied inputs are consistent with the corresponding commitments:

$${π}_{i}^{L} ← ZKP \{ ( {u}_{i} , {s}_{i} ) : {c}_{{u}_{i}} = com ( {u}_{i} , {s}_{i} ) \} .$$

The commits cᵤ_{ᵢ} and the

$$ZKP {π}_{i}^{L}$$

are forwarded to the prover 310.

At 352, a DOPRF is executed, between the prover and the verifier/list holder, to PRF evaluate the checklist L. Here, the verifier/list holder 320 provides as inputs to a DOPRF: the checklist L, its PRF key share k_{L}, and the commit cₖ_{_{P}} of the prover's key share k_{P}. The prover 310 provides as inputs to the DOPRF: its PRF key share k_{P}, the commit cₖ_{_{L}} of the list holder's PRF key share k_{L}, and the commits {cᵤ_{ᵢ}}ᵤ_{ᵢ}_{∈L} for each entry in the checklist L. In the example of FIG. 3, specifically a shuffled committed-input-&-key-shares DOPRF is performed. The output is the set of results for operating the DOPRF based on the two key shares and the entries in the checklist, where each entry in the results set corresponds to an entry in the checklist (i.e., Y={Fₖ_{_{P}}_{,k}_{_{L}}(uᵢ)|uᵢ∈L}). The output may be provided to both the prover 310 and the verifier/list holder 320.

At 354, a DOPRF is executed, between the prover and the verifier/list holder, to PRF evaluate the identity u of the prover 310. Here, the verifier/list holder 320 provides as inputs to a DOPRF: its PRF key share k_{L} and the commit cₖ_{_{P}} for the prover's PRF key share k_{P}. The prover 210 provides as inputs to the DOPRF: its key share k_{P}, its identity u, and the commit cₖ_{_{L}} for the verifier/list holder's PRF key share k_{L}. A committed-input-&-key-shares DOPRF is then performed to determine the result of the DOPRF on the identity u, using the key shares k_{P}, k_{L} (i.e., Fₖ_{_{P}}_{,k}_{_{L}}(u) and a second commit c₂ for the identity u (i.e., c₂←com(u;r₂)).

At 356, the prover 310 provides a second ZKP of input consistency π₂:

$${π}_{2} ← ZKP \{ ∃ ( u , {r}_{1} , {r}_{2} ) \vert {c}_{1} = com ( u ; {r}_{1} ) \hat{} {c}_{2} = com ( u ; {r}_{2} ) \} .$$

At 358, the verifier/list holder 320 determines whether Fₖ_{_{P}}_{,k}_{_{L}}(u) belongs to one of Y={Fₖ_{_{P}}_{,k}_{_{L}}(uᵢ)|uᵢ∈L}. If the answer is yes, the membership test is passed in the case of a whitelist or failed in the case of blacklist.

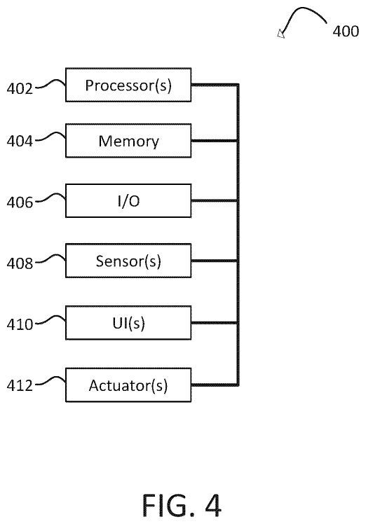

Referring to FIG. 4, a processing system 400 can include one or more processors 402, memory 404, one or more input/output devices 406, one or more sensors 408, one or more user interfaces 410, and one or more actuators 412. Processing system 400 can be representative of each computing system disclosed herein.

Processors 402 can include one or more distinct processors, each having one or more cores. Each of the distinct processors can have the same or different structure. Processors 402 can include one or more central processing units (CPUs), one or more graphics processing units (GPUs), circuitry (e.g., application specific integrated circuits (ASICs)), digital signal processors (DSPs), and the like. Processors 402 can be mounted to a common substrate or to multiple different substrates.

Processors 402 are configured to perform a certain function, method, or operation (e.g., are configured to provide for performance of a function, method, or operation) at least when one of the one or more of the distinct processors is capable of performing operations embodying the function, method, or operation. Processors 402 can perform operations embodying the function, method, or operation by, for example, executing code (e.g., interpreting scripts) stored on memory 404 and/or trafficking data through one or more ASICs. Processors 402, and thus processing system 400, can be configured to perform, automatically, any and all functions, methods, and operations disclosed herein. Therefore, processing system 400 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 400 can be configured to perform task “X”. Processing system 400 is configured to perform a function, method, or operation at least when processors 402 are configured to do the same.

Memory 404 can include volatile memory, non-volatile memory, and any other medium capable of storing data. Each of the volatile memory, non-volatile memory, and any other type of memory can include multiple different memory devices, located at multiple distinct locations and each having a different structure. Memory 404 can include remotely hosted (e.g., cloud) storage.

Examples of memory 404 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 404.

Input-output devices 406 can include any component for trafficking data such as ports, antennas (i.e., transceivers), printed conductive paths, and the like. Input-output devices 406 can enable wired communication via USB®, DisplayPort®, HDMI®, Ethernet, and the like. Input-output devices 406 can enable electronic, optical, magnetic, and holographic, communication with suitable memory 406. Input-output devices 406 can enable wireless communication via WiFi®, Bluetooth®, cellular (e.g., LTE®, CDMA®, GSM®, WiMax®, NFC®), GPS, and the like. Input-output devices 406 can include wired and/or wireless communication pathways.

Sensors 408 can capture physical measurements of environment and report the same to processors 402. User interface 410 can include displays, physical buttons, speakers, microphones, keyboards, and the like. Actuators 412 can enable processors 402 to control mechanical forces.

Processing system 400 can be distributed. For example, some components of processing system 400 can reside in a remote hosted network service (e.g., a cloud computing environment) while other components of processing system 400 can reside in a local computing system. Processing system 400 can have a modular design where certain modules include a plurality of the features/functions shown in FIG. 4. For example, I/O modules can include volatile memory and one or more processors. As another example, individual processor modules can include read-only-memory and/or local caches.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A computer-implemented method for anonymous credential verification and privacy-preserving membership test, the method comprising:
executing a first committed-input-and-key-shares distributed oblivious pseudorandom function (DOPRF) protocol to obtain a set of first pseudorandom function (PRF) results, each result corresponding to one of a plurality of elements in a checklist held by a list holder;
executing a second committed-input-and-key-shares DOPRF protocol to obtain a second PRF result corresponding to an identity of a prover; and
determining whether one of the elements in the checklist corresponds to the identity of the prover based upon the set of first PRF results and the second PRF result.

2: The method as claimed in claim 1, wherein the first committed-input-and-key-shares DOPRF protocol is a shuffled committed-input-&-key-shares DOPRF protocol, and the set of first PRF results are shuffled as compared to an order of the elements in the checklist to provide a pseudorandom representation of the checklist.

3: The method of claim 1, the method further comprising:
receiving, from the prover, a first commitment to the identity of the prover, a first zero-knowledge proof (ZKP) binding the identity of the prover to verifiable anonymous credentials (VAC) of the prover; and at least one of a pseudonym of the identity or a corresponding credentials, the VAC comprising the identity, the pseudonym, and the credentials; and
verifying that the first ZKP is valid; and
verifying the credentials.

4: The method of claim 1,
wherein the inputs to the first committed-input-and-key-shares DOPRF protocol comprise: a first pseudorandom function (PRF) key share of the prover; a first commitment corresponding to a second PRF key share of the list holder; the second PRF key share of the list holder; a set of commitments corresponding to the elements in the checklist; a second commitment corresponding to the PRF key share of the prover; and the checklist, and
wherein the set of first PRF results comprises values of a pseudorandom function evaluated on the plurality of elements of the checklist, using the first PRF key share and the second PRF key share.

5: The method of claim 1,
wherein the inputs to the second committed-input-and-key-shares DOPRF protocol comprise: a first pseudorandom function (PRF) key share of the prover, a first commitment corresponding to a second PRF key share of the list holder, the identity of the prover; the second PRF key share of the list holder, and a second commitment corresponding to the first PRF key share of the prover, and
wherein the second PRF result comprises a value of the pseudorandom function evaluated on the identity of the prover, using the first PRF key share and the second PRF key share.

6: The method of claim 1, wherein executing the second committed-input-and-key-shares DOPRF protocol further obtains a third commitment to the identity of the prover.

7: The method of claim 1, the method further comprising, at a verifier, before executing the first committed-input-and-key-shares DOPRF protocol and the second committed-input-and-key-shares DOPRF protocol:
receiving, from the list holder, a commitment to a first pseudorandom function (PRF) key share, commitments to the plurality of elements of the checklist, and a zero-knowledge proof (ZKP) that the checklist supplied for the first DOPRF protocol is consistent with the commitments to the plurality of elements of the checklist, and sending the commitment to the first PRF key share, the commitments to the plurality of elements of the checklist, and the ZKP to the prover; and
receiving, from the prover, a commitment to a second PRF key share, and sending the commitment to the second PRF key share to the list holder,
wherein the first PRF key share was selected uniformly at random by the list holder, and the second PRF key share was selected uniformly at random by the prover.

8: The method as claimed in claim 7, the method further comprising, at the verifier, after executing the first committed-input-and-key-shares DOPRF protocol and the second committed-input-and-key-shares DOPRF protocol:
receiving, from the prover, a second ZKP of a consistency between the first commitment to the identity of the prover and a second commitment to the identity of the prover from in the second committed-input-and-key-shares DOPRF protocol; and
verifying the second ZKP.

9: The method of claim 8, wherein the checklist is a whitelist, the method further comprising:
upon determining that the identity of the prover belongs to one of the plurality of elements of the checklist and upon verifying that the second ZKP is valid, authenticating the prover.

10: The method of claim 8, wherein the checklist is a blacklist, the method further comprising:
upon determining that the identity of the prover does not correspond to any of the plurality of elements of the checklist and upon verifying that the second ZKP is valid, authenticating the prover.

11: The method as claimed in claim 7, wherein the verifier executes the first committed-input-and-key-shares DOPRF protocol, executes the second committed-input-and-key-shares DOPRF protocol, and determines whether one of the elements in the checklist corresponds to the identity of the prover.

12: The method as claimed in claim 1, wherein the verifier and the list holder coincide on a same computer.

13: The method as claimed in claim 1, wherein determining whether one of the elements in the checklist corresponds to the identity of the prover comprises determining whether a value of a pseudorandom function evaluated on the identity of the prover matches with any values of the pseudorandom function evaluated on the plurality of elements of the checklist.

14: A computer system comprising one or more hardware processors which, alone or in combination, are configured to provide for execution of the following steps:
executing a first committed-input-and-key-shares distributed oblivious pseudorandom function (DOPRF) protocol to obtain a set of first pseudorandom function (PRF) results, each result corresponding to one of a plurality of elements in a checklist held by a list holder;
executing a second committed-input-and-key-shares DOPRF protocol to obtain a second PRF result corresponding to an identity of a prover; and
determining whether one of the elements in the checklist corresponds to the identity of the prover based upon the set of first PRF results and the second PRF result.

15: A tangible, non-transitory computer-readable medium having instructions thereon which, upon being executed by one or more hardware processors, alone or in combination, provide for execution of the following steps:
executing a first committed-input-and-key-shares distributed oblivious pseudorandom function (DOPRF) protocol to obtain a set of first pseudorandom function (PRF) results, each result corresponding to one of a plurality of elements in a checklist held by a list holder;
executing a second committed-input-and-key-shares DOPRF protocol to obtain a second PRF result corresponding to an identity of a prover; and
determining whether one of the elements in the checklist corresponds to the identity of the prover based upon the set of first PRF results and the second PRF result.
